(19) United States
(12) Patent Application Publication
(10) Pub. No.: US 2021/0334912 A1
(43) Pub. Date: Oct. 28, 2021

(54) METHOD AND SYSTEM FOR OBTAINING DESIGN SCHEME OF COLLABORATIVELY OPTIMIZED INTEGRATED ENERGY SYSTEM

(71) Applicant: SHANDONG UNIVERSITY, Jinan (CN)

(72) Inventors: Chenghui ZHANG, Jinan (CN); Bo SUN, Jinan (CN); Haoran LI, Jinan (CN)

(73) Assignee: SHANDONG UNIVERSITY, Jinan (CN)

(21) Appl. No.: 17/218,641

(22) Filed: Mar. 31, 2021

(30) Foreign Application Priority Data
Apr. 22, 2020 (CN) 2020103207273

(51) Int. Cl. G06Q 50/06; H02J 3/14; H02J 13/00

(52) U.S. Cl. CPC G06Q 50/06; H02J 3/144; H02J 13/00004; H02J 2203/20; H02J 2310/12; H02J 2310/60; H02J 2310/64; H02J 13/00032

(57) ABSTRACT

A method and system for obtaining a design scheme of a collaboratively optimized integrated energy system which resolves a problem of independent optimization failure caused by multi-device and multi-condition, structure complexity and diversity, and strong coupling of multi-energy flow operation. The method includes: determining types and a quantity of candidate devices, and taking a total quantity as a system scale during optimization; determining a quantity and types of variables using a unified model representing the integrated energy system as a chain structure; performing simulation by using a chain operating mode to obtain operating data, and solving variables to obtain a ranking result of the devices in the chain structure, by using a structure order, installed capacity, and control parameters of the devices as variables, and by using primary energy consumption, energy supply costs, and carbon emission as objectives; and obtaining a system design result according to the solving result.

### BACKGROUND

### Technical Field

The present disclosure relates to the technical field of integrated energy system planning, and in particular, to a method and a system for obtaining a design scheme of a collaboratively optimized integrated energy system.

### Related Art

The description in this section merely provides background information related to the present disclosure and does not necessarily constitute the prior art.

An integrated energy system meets integrated energy requirements of users on cooling, heating, and electricity simultaneously by using energy in a complementary manner, for example, solar energy, biomass energy, and natural gas, which dramatically improves an ability of the integrated energy system for dealing with load changes. The system includes various types of energy conversion units, and integration forms are complex and diversified. Access of intermittent renewable energy not only deepens multi-energy flow complexity of the system, but also brings in a large quantity of random factors for operating states, so that a coupling relationship between a capacity configuration and an operating mode in the system is further deepened actually. Not only does model selection of power devices have decisive impacts on overall performance, but also disparate features of different power techniques lead to not exactly the same collaborative operating manners among the devices, so that system structures are complex and diversified.

In addition, access of new energy, such as, wind, light, and biomass, large-scale energy storage devices, and a large number of flexible loads enables operating manners of the integrated energy system to be random and variable. There is an unprecedented deepened coupling relationship among a structure, capacity and operations in system design. As a result, a conventional multi-objective optimization method for a single structure or capacity is difficult to be competent, and therefore, a new integrated design method is required.

Therefore, a problem to be resolved in integrated design of the integrated energy system is determining system energy flow structures, device capacity and complementary operating manners by using performance as an optimization objective, and by using a device, energy, and system parameters as input. Furthermore, it has become a hotspot in current study that has raised considerable concern from the academia and the business circle to comprehensively evaluate essential properties of different energy conversion techniques, implement system optimized configuration design, properly plan initial investment for devices, and accurately match energy supply-demand relationships according to changes of cooling, heating, and electric loads and actual user requirements.

The inventor has found in research that, currently, most scholars around the world integrate and optimize optimization operations or capacity configurations of systems by using intelligence algorithms, and in a manner of heuristic search. However, if multi-objective optimization of device capacity and multi-objective optimization of operating parameters are completed respectively with an idea of nest optimization, an amount of calculation and a calculation time are doubled, and therefore it is difficult to find a solution accurately. In addition, if the nest optimization of the structure of the integrated energy system is added, no solution can be found.

### SUMMARY

To overcome the foregoing disadvantages in the prior art, the present disclosure provides a method for obtaining an integrated design scheme of a collaboratively optimized integrated energy system. Based on complementary structural relationships among a plurality of types of energy conversion devices, and an intrinsic constraint relationship between a capacity configuration and key operating parameters, a unified model of the devices is constructed to describe connection manners, operating manners and control parameters of the integrated energy system, so that a structure, capacity and operations of the integrated energy system are integrated, to implement collaborative optimization in system design.

To achieve the foregoing objective, one or more embodiments of the present disclosure provide the following technical solutions:

a method for obtaining a design scheme of a collaboratively optimized integrated energy system, including:

determining types of candidate devices and a quantity of each type of devices, and taking a total quantity of devices as an upper limit of a length of the system during integrated optimization;

determining, according to the total quantity of devices of the system and the types of the devices, a quantity and types of variables by using a unified model, the variables including a device order, device capacity, and operating parameters;

representing the structure of the integrated energy system as a chain structure, based on the unified model of the devices;

performing simulation by using a chain operating mode to obtain operating data, based on the chain structure of the system; and

solving, by using a structure order, installed capacity, and control parameters of the devices as variables and by using primary energy consumption, energy supply costs, and carbon emission as objectives, the variables to obtain an optimal scheme of integrated design of the system, the optimal scheme including system chain structures, system network structures, device capacity, and operating parameters.

In a further technical solution, if in a solving result, capacity of a device at an order position is 0, the device is deleted.

In a further technical solution, the unified model includes energy input, energy conversion, and energy output, and is used for describing connection manners, operating manners, and control parameters of the devices.

In a further technical solution, the devices in the integrated energy system include source control devices, load control devices, and self-control devices, and operating manners of the source control devices are controlled by such two parameters as energy input and device capacity;

operating manners of the load control devices are controlled by such three parameters as an energy requirement, a response rate, and device capacity; and

operating manners of the self-control devices are controlled by such three parameters as a charging/discharging rate, energy in an energy storage device, and device capacity.

In a further technical solution, the chain structure uniformly connects heterogeneous energy resources, functionally different devices, and diversified energy consumption requirements to an energy flow set in which a plurality of types of energy are parallel to each other, energy transfer relationships of system operations between the devices are embodied in the order of the devices in the chain structure, and energy transfer between two associated devices is not affected by any unassociated device between the two devices.

In a further technical solution, the chain structure and the network structure are transformed into each other: optimizing the system structure according to the order of the devices in the chain structure, to obtain the network structure.

In a further technical solution, transformation between the chain structure and the network structure includes:

model simplification: reserving associated energy input and output, removing unassociated energy input and output, and simplifying connecting wires in the unified model, according to a device energy conversion function;

ordered arrangement: successively arranging such three types of elements as resources, devices, and loads first according to network structure requirements, and then successively arranging the devices according to the order in the chain structure;

device connection: successively connecting the devices to the resources and the loads according to types of available energy input and target energy output, and connecting, when a device is connected, energy input of the device to energy output of other devices and resources of a same type; and

structure arrangement: performing standardized arrangement on the structure after the device connection, to obtain the network structure.

In a further technical solution, the chain operating mode of the chain structure includes:

determining energy input and output of the system at a current moment by using an available amount of energy resources as available energy input of the system, and by using energy consumption loads as target energy output;

successively operating the devices according to the order of the devices in the chain structure;

performing energy conversion by a device in a control manner of the device, according to the energy input and output;

adjusting the available energy input and the target energy output of the system according to an energy conversion result of the device, for subsequent operations of the device; and

performing statistics on operation conditions of all the devices, completing a system operation at a current moment, if all the target energy output is 0 after the system operation, all user requirements being met, and calculating energy consumption of the system operation according to initial available energy input and available energy input after the operation.

In another aspect, to achieve the foregoing objective, one or more embodiments of the present disclosure provide the following technical solutions:

a system for obtaining a design scheme of a collaboratively optimized integrated energy system, including:

a device modeling module, constructing, according to types of candidate devices, based on a unified model of the devices, by using device functions and in an energy conversion manner, simulation models having device capacity and control parameters for the types of devices;

a chain structure module, according to the types of candidate devices and a quantity, arranging the devices according to a certain order, and representing the structure of the integrated energy system as a chain structure;

a simulation operation module, simulating energy production of the system in a chain operating mode, according to the device model and the chain structure, to meet energy consumption requirements at time points, and obtaining operating data; and

a design scheme solving module, solving, by using a structure order, installed capacity, and control parameters of the devices as variables, by using primary energy consumption, energy supply costs, and carbon emission as objectives, and by using the operating data obtained by performing the simulation in the chain operating mode of the chain structure as an evaluation basis, solving the variables to obtain an optimal scheme of integrated design of the system, the optimal scheme including system chain structures, system network structures, device capacity, and operating parameters.

The foregoing one or more technical solutions have the following beneficial effects:

The present disclosure constructs the unified model of the plurality of types of devices in the integrated energy system by using a uniform modeling method, and provides the operating manners and the control parameters of the types of devices; designs a mutual transformation method for the chain structure and the network structure, and optimizes the network structure by using the order of the devices in the chain structure; and designs an integrated design method for collaboratively optimizing the “system structure”, the “device capacity”, and the “operating parameters” by using the device order, the device capacity, and the control parameters as variables. Defects in an experience-based structure design method and disharmony of independent optimization of structure capacity parameters in the design of the integrated energy system are resolved, which not only decreases energy consumption, costs, and emission of a design result, but also simplifies calculation, and decreases workloads and time of the system design.

The present disclosure mines the complementary structural relationships among the plurality of types of energy conversion devices, and the intrinsic constraint relationship between the capacity configuration and the key operating parameters, and constructs an integrated optimization design method of integrated multi-energy complementary structure, device, and operation. The present disclosure is an integrated design method, and is an integrated design method that integrates the multi-energy complementary structure, the device capacity configurations, and the key operating parameters, which fundamentally resolves a problem of independent optimization failure caused by multi-device and multi-condition, structure complexity and diversity, and strong coupling of multi-energy flow operation.

### BRIEF DESCRIPTION OF THE DRAWINGS

The accompanying drawings constituting a part of the present disclosure are used to provide further understanding of the present disclosure. Exemplary embodiments of the present disclosure and descriptions thereof are used to explain the present disclosure, and do not constitute an improper limitation to the present disclosure.

FIG. 1 is a schematic diagram of a unified model and control manner classification of devices of an integrated energy system according to an embodiment of the present disclosure;

FIG. 2 is a schematic structural diagram of two types of integrated energy systems according to an embodiment of the present disclosure;

FIG. 3 is a schematic diagram of a transformation method of a chain structure and a network structure according to an embodiment of the present disclosure;

FIG. 4 is a schematic diagram of a chain operating mode of an integrated energy system according to an embodiment of the present disclosure;

FIG. 5 is a schematic diagram of user energy consumption requirements and amounts of renewable energy resources according to an embodiment of the present disclosure;

FIG. 6 is a schematic diagram of optimization design results of integrated energy systems in an example application according to an embodiment of the present disclosure; and

FIG. 7 is a schematic diagram of operation power output distribution of a designed system in an example application according to an embodiment of the present disclosure.

### DETAILED DESCRIPTION

It should be noted that the following detailed descriptions are all exemplary and are intended to provide a further description of the present disclosure. Unless otherwise specified, all technical and scientific terms used herein have the same meanings as commonly understood by a person of ordinary skill in the art to which the present disclosure belongs.

It should be noted that terms used herein are only for describing specific implementations and are not intended to limit exemplary implementations according to the present disclosure. As used herein, the singular form is intended to include the plural form, unless the context clearly indicates otherwise. In addition, it should further be understood that terms “comprise” and/or “include” used in this specification indicate that there are features, steps, operations, devices, components, and/or combinations thereof.

The embodiments in the present disclosure and features in the embodiments may be mutually combined in a case that no conflict occurs.

### Embodiment 1

This embodiment discloses a method for obtaining a design scheme of a collaboratively optimized integrated energy system, which is an integrated design method. Based on a chain structure constructed by a unified model, this embodiment designs an integrated design method for collaboratively optimizing a “system structure”, “device capacity”, and “operating parameters” of the integrated energy system. In the integrated design method, by using a structure order, installed capacity, and control parameters of devices as variables, simulation is performed by using a chain operating mode to obtain operating data, and by using primary energy consumption, energy supply costs, and carbon emission as objectives, and by using an optimization method of a heuristic algorithm and an evaluation method of Pareto optimality, the variables are solved to obtain an optimization design result. The design method is specifically divided into the following four steps:

(1) determining types of candidate devices and a quantity of each type of devices according to requirements of the system design, and taking a total quantity of devices as an upper limit of a length of the system during integrated optimization;

(2) determining, according to the total quantity of devices of the system and the types of the devices, a quantity and types of variables in the optimization design by using a unified model, the variables including a device order, device capacity, and operating parameters;

(3) in the heuristic algorithm, performing simulation by using a chain operating mode to obtain operating data, calculating evaluation indicators, and solving a design result by using an evaluation method of Pareto optimality; and

(4) obtaining a system design result according to the solving result, the system design result including a system chain structure, a system network structure, device capacity, and operating parameters. If in the solving result, capacity of a device at an order position is 0, the device is deleted.

The unified model of the devices, used for describing connection manners, operating manners, and control parameters, is described in detail below, so that a structure, capacity and operations of the integrated energy system are integrated, to implement collaborative optimization in system design.

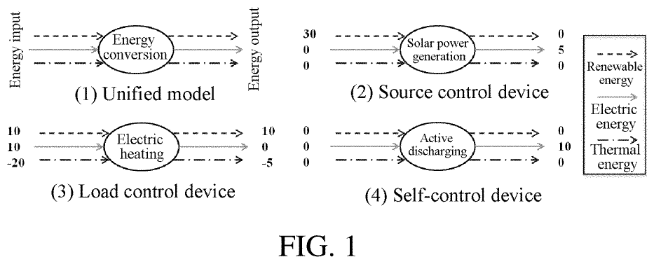

The unified model provided in this embodiment includes such three parts as energy input, energy conversion, and energy output, as shown by (1) in FIG. 1. For a specific device, when energy conversion is performed, only energy related to functions of the device is consumed and produced, and other input and output energy remains unchanged. According to different control manners of energy conversion, devices may be divided into such three types as source control devices, load control devices, and self-control devices, as shown by (2) to (4) in FIG. 1.

Specifically, for source control devices, such as, wind power source control devices and photovoltaic source control devices, operating manners are controlled by such two parameters as energy input and device capacity. A formula is expressed as:

Q^{out}=f(Qⁱⁿ,C)

In the formula, Q^{out}represents energy output, Qⁱⁿ represents energy input, and C represents device capacity.

For load control devices, such as generator sets and boilers, operating manners are controlled by such three parameters as an energy requirement, a response rate, and device capacity. A formula is expressed as:

Qⁱⁿ=f(Q^{out}, r, C)

In the formula, Q^{out} represents energy output, Qⁱⁿ represents energy input, r represents a response rate, and C represents device capacity.

For self-control devices, such as energy storage batteries, operating manners are controlled by such three parameters as a charging/discharging rate, energy in an energy storage device, and device capacity. A formula is expressed as:

Q^{out}=f(a, soc, C)

In the formula, Q^{out} represents energy output, a represents a charging/discharging rate, soc represents energy in an energy storage device, and C represents device capacity.

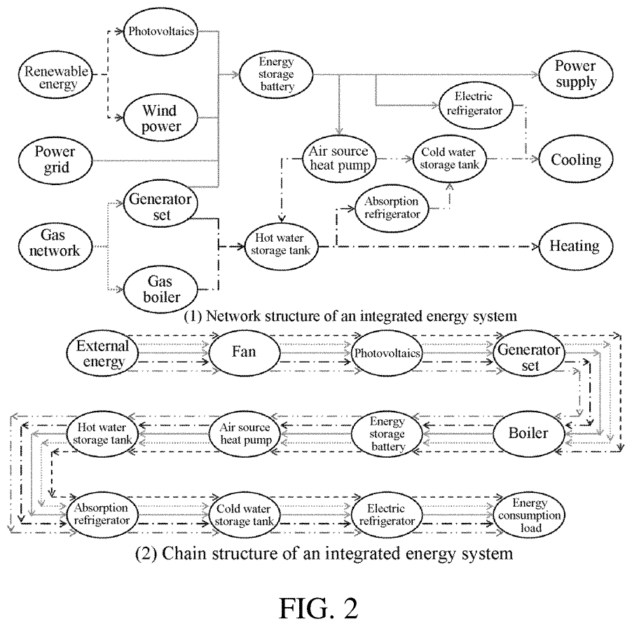

The design method of the system structure: The integrated energy system includes a plurality of types of devices, and energy flow is complex. In a conventional method, a system is represented as a network structure, as shown by (1) in FIG. 2. However, in the present disclosure, based on a unified model of devices, the system structure is represented as a chain structure, as shown by (2) in FIG. 2. The chain structure provided in the present disclosure features by uniformly connecting heterogeneous energy resources, functionally different devices, and diversified energy consumption requirements to an energy flow set in which a plurality of types of energy are parallel to each other. Energy transfer relationships of system operations between the devices are embodied in the order of the devices in the chain structure, and energy transfer between two associated devices is not affected by any unassociated device between the two devices. Therefore, a complex relationship of multi-energy flow in the system structure is simplified into an order relationship among the devices, so that an optimization design problem of the system structure is simplified into a ranking problem of the devices in the chain structure.

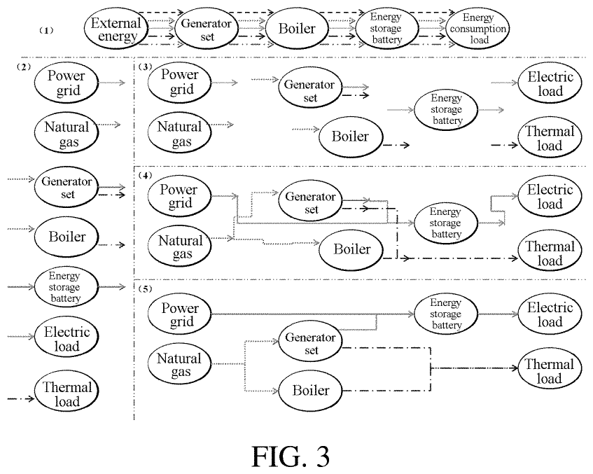

A transformation method for the chain structure and the network structure is divided into four steps. (1) in FIG. 3 shows a chain structure of a simple system including two types of resources, three devices, and two types of loads, and the process of transformation of the chain structure to a network structure is as follows:

(1) model simplification: reserving associated energy input and output, removing unassociated energy input and output, and simplifying connecting wires in the unified model, according to a device energy conversion function, as shown by (2) in FIG. 3;

(2) ordered arrangement: successively arranging such three types of elements as resources, devices, and loads first according to network structure requirements, and then successively arranging the devices according to the order in the chain structure, as shown by (3) in FIG. 3;

(3) device connection: successively connecting the devices to the resources and the loads according to types of available energy input and target energy output, and connecting, when a device is connected, energy input of the device to energy output of other devices and resources of a same type, as shown by (4) in FIG. 3; and

(4) structure arrangement: performing standardized arrangement on the structure after the device connection, to obtain the network structure, as shown by (5) in FIG. 3.

An operating mode of the system:

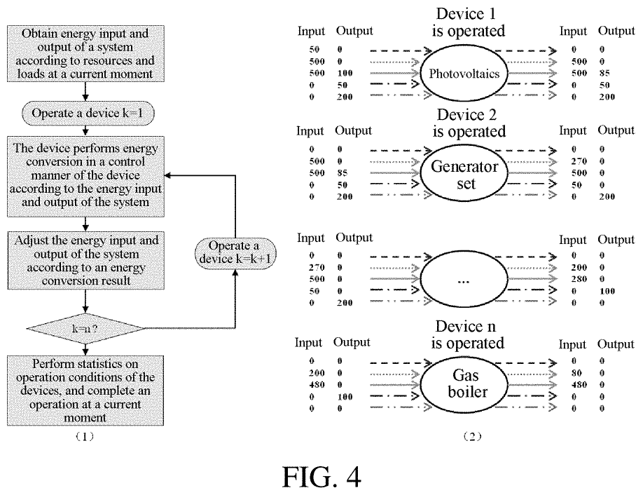

The present disclosure provides a chain operating mode of an integrated energy system based on a unified model of devices and a chain structure of the system. As shown by (1) in FIG. 4, mainly five steps are included:

(1) determining energy input and output of the system at a current moment by using an available amount of energy resources as available energy input of the system, and by using energy consumption loads as target energy output;

(2) successively operating the devices according to the order of the devices in the chain structure;

(3) performing energy conversion by a device in a control manner of the device, according to the energy input and output;

(4) adjusting the available energy input and the target energy output of the system according to an energy conversion result of the device, for subsequent operations of the device, as shown by (2) in FIG. 4; and

(5) performing statistics on operation conditions of all the devices, completing a system operation at a current moment, if all the target energy output is 0 after the system operation, all user requirements being met, and calculating energy consumption of the system operation according to initial available energy input and available energy input after the operation.

Example Application

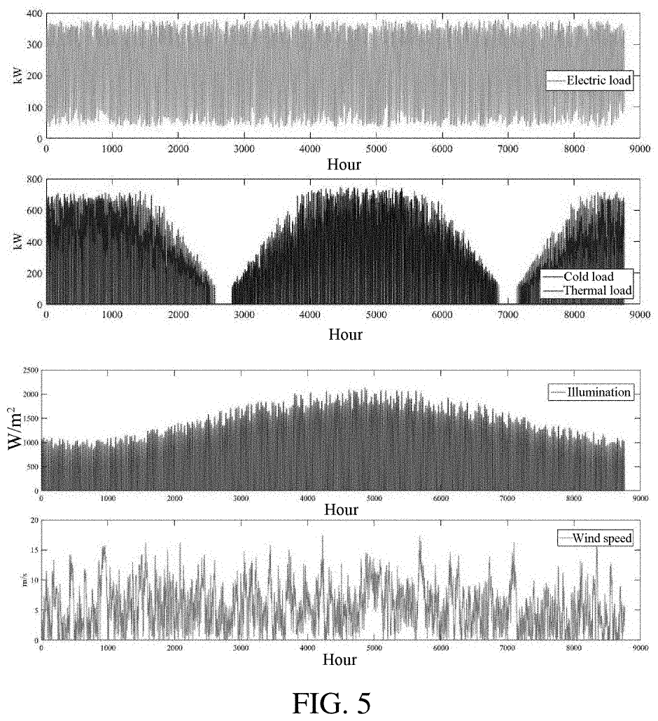

An integrated design method for an integrated energy system provided in the present disclosure is applicable to resolving a problem that a system structure, device capacity, and operating parameters are difficult to optimize due to various types and diverse quantities of devices in the system, and application manners and utility effects are specifically described by using the following examples. In this example, a target user is a commercial building, and energy requirements of the commercial building may be divided into a perennial electricity requirement, a summer cooling requirement, and a winter heating requirement. Data per hour of energy consumption requirements, solar radiation, and wind speed is shown in FIG. 5. Candidate device information during the system design is shown in Table 1. Table 2 lists prices and emission rates of natural gas and a power grid available to users.

TABLE 1
Candidate device information in an example application

| | | | Quantity | | |
|---|---|---|---|---|---|
| Category | Capacity interval | Unit | limitation | Price | |
| Photovoltaics | {0 2 4 . . . 30} | kW | 1 | 7000 | yuan/kW |
| Micro fan | {0 2 4 . . . 20} | kW | 1 | 9000 | yuan/kW |
| Ground source heat pump | {0 1 2 . . . 10} | m³ | 1 | 2500 | yuan/m³ |
| Generator set | {0 10 20 . . . 500} | kW | 2 | 5000 | yuan/kW |
| Gas boiler | {0 10 20 . . . 500} | kW | 2 | 1000 | yuan/kW |
| Absorption refrigerator | {0 10 20 . . . 500} | kW | 2 | 2000 | yuan/kW |
| Electric refrigerator | {0 10 20 . . . 500} | kW | 1 | 1500 | yuan/kW |
| Air source heat pump | {0 10 20 . . . 500} | kW | 2 | 2500 | yuan/kW |
| Energy storage battery | {0 10 20 . . . 500} | kWh | 1 | 4000 | yuan/kWh |
| Cold water storage tank | {0 1 2 . . . 20} | m³ | 1 | 500 | yuan/m³ |
| Hot water storage tank | {0 1 2 . . . 20} | m³ | 1 | 500 | yuan/m³ |

TABLE 2
Energy price and emission data

| Category | Price | |
|---|---|---|
| Power purchase price | 1.20/0.90/0.60 | yuan/kWh |
| Emission rate of a power grid | 0.785 | kg/kWh |
| Average power generation | 0.35 | |
| efficiency of a power grid | | |
| Gas price | 2.50 | yuan/m³ |
| Emission rate of gas | 2.07 | kg/m³ |
| Calorific value of gas | 9.60 | kWh/m³ |

In the process of optimization design, with reference to a unified model of candidate devices, determined optimization variables are shown in Table 3. Because there is no source control parameter in a unified model of photovoltaics and a fan, there is no corresponding parameter variable in the optimization design. As there are two modes during energy conversion of a generator set and an air source heat pump, and each of the modes has a load control parameter, two parameter variables are included in the optimization design. Values of self-control parameters of energy storage devices vary according to peak and valley changes of loads, and therefore each of the energy storage devices includes four corresponding parameter variables in the optimization design.

TABLE 3
Optimization variables in an example application

| To-be-optimized | Order | Capacity | Parameter |
|---|---|---|---|
| device | variable | variable | variable |
| Photovoltaics | x₁ | y₁ | — |
| Micro fan | x₂ | y₂ | — |
| Ground source | x₃ | y₃ | — |
| heat pump | | | |
| Generator set 1 | x₄ | y₄ | z₁ z₂ |
| Generator set 2 | x₅ | y₅ | z₃ z₄ |
| Gas boiler 1 | x₆ | y₆ | z₅ |
| Gas boiler 2 | x₇ | y₇ | z₆ |
| Absorption | x₈ | y₈ | z₇ |
| refrigerator 1 | | | |
| Absorption | x₉ | y₉ | z₈ |
| refrigerator 2 | | | |
| Electric | x₁₀ | y₁₀ | z₉ |
| refrigerator | | | |
| Air source heat | x₁₁ | y₁₁ | z₁₀ z₁₁ |
| pump 1 | | | |
| Air source heat | x₁₂ | y₁₂ | z₁₂ z₁₃ |
| pump 2 | | | |
| Energy storage | x₁₃ | y₁₃ | z₁₄ z₁₅ |
| battery | | | z₁₆ z₁₇ |
| Cold water | x₁₄ | y₁₄ | z₁₈ z₁₉ |
| storage tank | | | z₂₀ z₂₁ |
| Hot water storage | x₁₅ | y₁₅ | z₂₂ z₂₃ |
| tank | | | z₂₄ z₂₅ |

An algorithm selected in this example is a Strength Pareto Evolutionary Algorithm (SPEA-II), to find a solution by programming in Matlab. There are 55 optimization variables in the algorithm, a population size is 300, and a quantity of iterations is 300. Operations are performed by using 50 computing clusters of parallel computing to find a solution, a total time is 16.5 hours, and obtained optimization design results are shown in Table 4.

TABLE 4
Variable solving results of system design in an example application

| | Order | | Capacity | | | |
|---|---|---|---|---|---|---|
| Installed device | variable | | variable | | Parameter variable | |
| Photovoltaics | x₁ | 13 | y₁ | 30 | — | — |
| Micro fan | x₂ | 3 | y₂ | 20 | — | — |
| Ground source | x₃ | 1 | y₃ | 10 | — | — |
| heat pump | | | | | | |
| Generator set 1 | x₄ | 7 | y₄ | 160 | z₁ z₂ | 0.90 0.50 |
| Generator set 2 | x₅ | 4 | y₅ | 140 | z₃ z₄ | 0.80 0.40 |
| Gas boiler 1 | x₆ | 14 | y₆ | 0 | z₅ | 0.30 |
| Gas boiler 2 | x₇ | 8 | y₇ | 370 | z₆ | 0.60 |
| Absorption | x₈ | 5 | y₈ | 200 | z₇ | 0.90 |
| refrigerator 1 | | | | | | |
| Absorption | x₉ | 2 | y₉ | 240 | z₈ | 0.90 |
| refrigerator 2 | | | | | | |
| Electric | x₁₀ | 9 | y₁₀ | 120 | z₉ | 0.95 |
| refrigerator | | | | | | |
| Air source heat | x₁₁ | 12 | y₁₁ | 70 | z₁₀ z₁₁ | 0.90 0.70 |
| pump 1 | | | | | | |
| Air source heat | x₁₂ | 11 | y₁₂ | 0 | z₁₂ z₁₃ | 0.60 0.50 |
| pump 2 | | | | | | |
| Energy storage | x₁₃ | 15 | y₁₃ | 140 | z₁₄ z₁₅ z₁₆ z₁₇ | 0.00 0.40 0.15 0.00 |
| battery | | | | | | |
| Cold water | x₁₄ | 6 | y₁₄ | 20 | z₁₈ z₁₉ z₂₀ z₂₁ | 0.20 −0.20 0.40 0.20 |
| storage tank | | | | | | |
| Hot water | x₁₅ | 10 | y₁₅ | 20 | z₂₂ z₂₃ z₂₄ z₂₅ | −0.15 0.20 −0.15 −0.10 |
| storage tank | | | | | | |

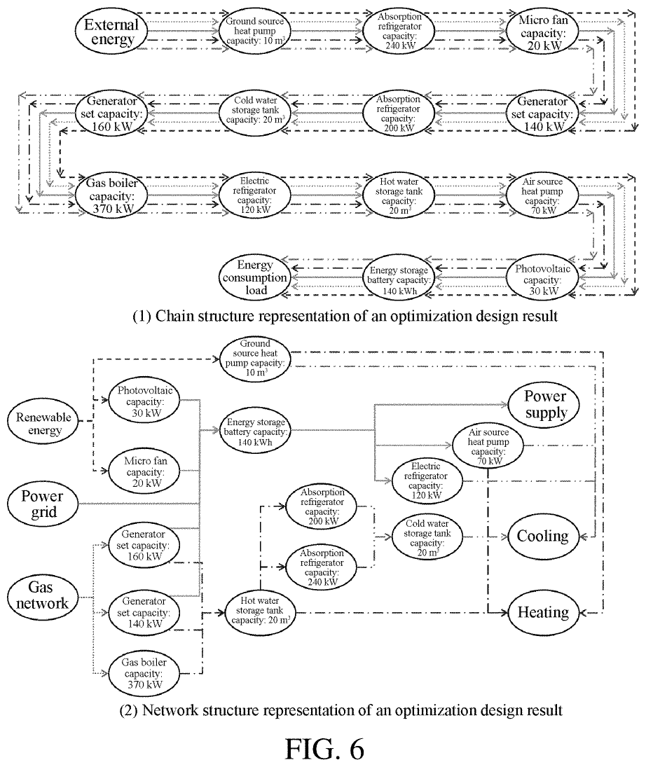

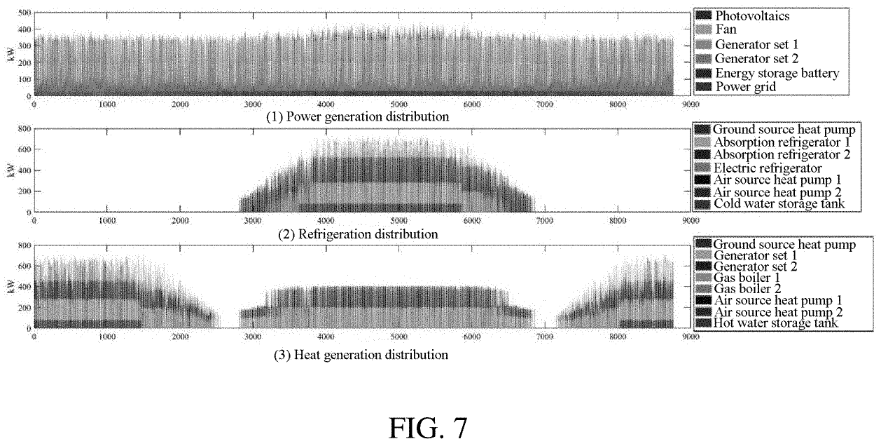

A corresponding chain structure and a corresponding network structure are shown in FIG. 6. Operation power output of each device of the system in annual operations is shown in FIG. 7. Performance indicators of the system are respectively a primary energy consumption rate 156.3%, an energy supply cost 0.4343 yuan/kWh, and a carbon dioxide emission rate 0.3215 kg/kWh.

Feasibility and flexibility of the present disclosure are verified through research by using examples. Compared with a conventional design method, the method not only implements integrated design of an integrated energy system and improves design accuracy, but also simplifies a calculation amount in the optimization process and improves a calculation speed.

The present disclosure constructs the unified model of the plurality of types of devices in the integrated energy system by using a uniform modeling method, and provides the operating manners and the control parameters of the types of devices;

the present disclosure designs a mutual transformation method for the chain structure and the network structure, and optimizes the system structure according to the order of the devices in the chain structure, to obtain the network structure;

the present disclosure provides the chain operating mode, and according to the order of the devices and the energy input and output, energy conversion is performed successively; and

the present disclosure designs the integrated design method for collaboratively optimizing the “structure”, the “capacity”, and the “operating parameters” by using the structure order, the installed capacity, and the control parameters of the devices as variables.

### Embodiment 2

An objective of this embodiment is to provide a system for obtaining a design scheme of a collaboratively optimized integrated energy system, including:

a unified model construction module, determining types and a quantity of candidate devices, and taking a total quantity of devices as an upper limit of a length of the system during integrated optimization; and

determining, according to the total quantity of devices of the system and the types of the devices, a quantity and types of variables by using a unified model, the variables including a device order, device capacity, and operating parameters;

a chain structure construction module, representing the structure of the integrated energy system as a chain structure, based on the unified model of the devices; and

a solving module, performing simulation by using a chain operating mode of the chain structure to obtain operating data, and solving variables to obtain a ranking result of the devices in the chain structure, by using a structure order, installed capacity, and control parameters of the devices as variables, and by using primary energy consumption, energy supply costs, and carbon emission as objectives; and

obtaining a system design result according to the solving result, the system design result including a system chain structure, a system network structure, device capacity, and operating parameters.

### Embodiment 3

An objective of this embodiment is to provide a computing apparatus, including a memory, a processor, and a computer program stored in the memory and executable on the processor, where when the processor executes the program, the following steps are implemented, including:

determining types and a quantity of candidate devices, and taking a total quantity of devices as an upper limit of a length of the system during integrated optimization;

determining, according to the total quantity of devices of the system and the types of the devices, a quantity and types of variables by using a unified model, the variables including a device order, device capacity, and operating parameters;

representing the structure of the integrated energy system as a chain structure, based on the unified model of the devices;

performing simulation by using a chain operating mode of the chain structure to obtain operating data, and solving variables to obtain a ranking result of the devices in the chain structure, by using a structure order, installed capacity, and control parameters of the devices as variables, and by using primary energy consumption, energy supply costs, and carbon emission as objectives; and

obtaining a system design result according to the solving result, the system design result including a system chain structure, a system network structure, device capacity, and operating parameters.

### Embodiment 4

An objective of this embodiment is to provide a computer-readable storage medium.

The computer-readable storage medium stores a computer program, and when the program is executed by a processor, the following steps are performed:

determining types and a quantity of candidate devices, and taking a total quantity of devices as an upper limit of a length of the system during integrated optimization;

determining, according to the total quantity of devices of the system and the types of the devices, a quantity and types of variables by using a unified model, the variables including a device order, device capacity, and operating parameters;

representing the structure of the integrated energy system as a chain structure, based on the unified model of the devices;

performing simulation by using a chain operating mode of the chain structure to obtain operating data, and solving variables to obtain a ranking result of the devices in the chain structure, by using a structure order, installed capacity, and control parameters of the devices as variables, and by using primary energy consumption, energy supply costs, and carbon emission as objectives; and

obtaining a system design result according to the solving result, the system design result including a system chain structure, a system network structure, device capacity, and operating parameters.

The steps involved in the apparatuses of Embodiment 2, Embodiment 3, and

Embodiment 4 correspond to the method Embodiment 1. For a specific implementation, refer to related descriptions of Embodiment 1. The term “computer-readable storage medium” should be understood as a single medium or a plurality of mediums including one or more instruction sets; and should also be understood as including any medium. The any medium can store, encode, or carry an instruction set used for being executed by a processor, and cause the processor to perform any method in the present disclosure.

A person skilled in the art should understand that the modules or steps in the present disclosure may be implemented by using a general-purpose computer apparatus. Optionally, they may be implemented by using program code executable by a computing apparatus, so that they may be stored in a storage apparatus and executed by the computing apparatus. Alternatively, the modules or steps are respectively manufactured into various integrated circuit modules, or a plurality of modules or steps thereof are manufactured into a single integrated circuit module. The present disclosure is not limited to any specific combination of hardware and software.

The foregoing descriptions are merely exemplary embodiments of the present disclosure, but are not intended to limit the present disclosure. The present disclosure may include various modifications and changes for a person skilled in the art. Any modification, equivalent replacement, or improvement made within the spirit and principle of the present disclosure shall fall within the protection scope of the present disclosure.

The specific implementations of the present disclosure are described above with reference to the accompanying drawings, but are not intended to limit the protection scope of the present disclosure. A person skilled in the art should understand that various modifications or deformations may be made without creative efforts based on the technical solutions of the present disclosure, and such modifications or deformations shall fall within the protection scope of the present disclosure.

1. A method for obtaining a design scheme of a collaboratively optimized integrated energy system, comprising:
determining types of candidate devices and a quantity of each type of devices, and taking a total quantity of devices as an upper limit of a length of the system during integrated optimization;
determining, according to the total quantity of devices of the system and the types of the devices, a quantity and types of variables by using a unified model, the variables comprising a device order, device capacity, and operating parameters;
representing the structure of the integrated energy system as a chain structure, based on the unified model of the devices;
performing simulation by using a chain operating mode to obtain operating data, based on the chain structure of the system; and
solving, by using a structure order, installed capacity, and control parameters of the devices as variables and by using primary energy consumption, energy supply costs, and carbon emission as objectives, the variables to obtain an optimal scheme of integrated design of the system, the optimal scheme comprising system chain structures, system network structures, device capacity, and operating parameters.

2. The method for obtaining a design scheme of a collaboratively optimized integrated energy system according to claim 1, wherein if in a solving result, capacity of a device at an order position is 0, the device is deleted.

3. The method for obtaining a design scheme of a collaboratively optimized integrated energy system according to claim 1, wherein the unified model comprises energy input, energy conversion, and energy output, and is used for describing connection manners, operating manners, and control parameters of the devices;
the devices in the integrated energy system comprise source control devices, load control devices, and self-control devices, and operating manners of the source control devices are controlled by such two parameters as energy input and device capacity;
operating manners of the load control devices are controlled by such three parameters as an energy requirement, a response rate, and device capacity; and
operating manners of the self-control devices are controlled by such three parameters as a charging/discharging rate, energy in an energy storage device, and device capacity.

4. The method for obtaining a design scheme of a collaboratively optimized integrated energy system according to claim 1, wherein the chain structure uniformly connects heterogeneous energy resources, functionally different devices, and diversified energy consumption requirements to an energy flow set in which a plurality of types of energy are parallel to each other, energy transfer relationships of system operations between the devices are embodied in the order of the devices in the chain structure, and energy transfer between two associated devices is not affected by any unassociated device between the two devices.

5. The method for obtaining a design scheme of a collaboratively optimized integrated energy system according to claim 1, wherein the chain structure is transformed into a network structure: optimizing the system structure according to the order of the devices in the chain structure, to obtain the network structure.

6. The method for obtaining a design scheme of a collaboratively optimized integrated energy system according to claim 5, wherein transformation between the chain structure and the network structure comprises:
model simplification: reserving associated energy input and output, removing unassociated energy input and output, and simplifying connecting wires in the unified model, according to a device energy conversion function;
ordered arrangement: successively arranging such three types of elements as resources, devices, and loads first according to network structure requirements, and then successively arranging the devices according to the order in the chain structure;
device connection: successively connecting the devices to the resources and the loads according to types of available energy input and target energy output, and connecting, when a device is connected, energy input of the device to energy output of other devices and resources of a same type; and
structure arrangement: performing standardized arrangement on the structure after the device connection, to obtain the network structure.

7. The method for obtaining a design scheme of a collaboratively optimized integrated energy system according to claim 1, wherein the chain operating mode of the chain structure comprises:
determining energy input and output of the system at a current moment by using an available amount of energy resources as available energy input of the system, and by using energy consumption loads as target energy output;
successively operating the devices according to the order of the devices in the chain structure;
performing energy conversion by a device in a control manner of the device, according to the energy input and output;
adjusting the available energy input and the target energy output of the system according to an energy conversion result of the device, for subsequent operations of the device; and
performing statistics on operation conditions of all the devices, completing a system operation at a current moment, if all the target energy output is 0 after the system operation, all user requirements being met, and calculating energy consumption of the system operation according to initial available energy input and available energy input after the operation.

8. A system for obtaining a design scheme of a collaboratively optimized integrated energy system, comprising:
a device modeling module, constructing, according to types of candidate devices, based on a unified model of the devices, by using device functions and in an energy conversion manner, simulation models having device capacity and control parameters for the types of devices;
a chain structure module, according to the types of candidate devices and a quantity, arranging the devices according to a certain order, and representing the structure of the integrated energy system as a chain structure;
a simulation operation module, simulating energy production of the system in a chain operating mode, according to the device model and the chain structure, to meet energy consumption requirements at time points, and obtaining operating data; and
a design scheme solving module, solving, by using a structure order, installed capacity, and control parameters of the devices as variables, by using primary energy consumption, energy supply costs, and carbon emission as objectives, and by using the operating data obtained by performing the simulation in the chain operating mode of the chain structure as an evaluation basis, the variables to obtain an optimal scheme of integrated design of the system, the optimal scheme comprising system chain structures, system network structures, device capacity, and operating parameters.

9. A computing device, comprising a memory, a processor, and a computer program stored in the memory and executable on the processor, wherein when the processor executes the program, steps of the method for obtaining a design scheme of a collaboratively optimized integrated energy system according to claim 1 are implemented.

10. A computer-readable storage medium storing a computer program, wherein when the program is executed by a processor, steps of the method for obtaining a design scheme of a collaboratively optimized integrated energy system according to claim 1 are performed.
